(19) United States
(12) Patent Application Publication
(10) Pub. No.: US 2018/0018326 A1
(43) Pub. Date: Jan. 18, 2018

(54) STORAGE MANAGEMENT SYSTEM, STORAGE SYSTEM, AND EXTENSION METHOD

(71) Applicant: HITACHI, LTD., Tokyo (JP)

(72) Inventor: Atsushi MIYAGAKI, Tokyo (JP)

(21) Appl. No.: 15/540,699

(22) PCT Filed: Jan. 30, 2015
(86) PCT No.: PCT/JP2015/052644

§ 371 Date: Jun. 29, 2017

(51) Int. Cl. G06F 17/30; H04L 29/08

(52) U.S. Cl. CPC G06F 17/302; H04L 67/1097; G06F 17/3007

(57) ABSTRACT

A storage management system applies respective storage management applications to an extended function in a storage system or to a new storage system, without having to add a processing logic for each storage management AP and without increasing the applied load. Therefore, multiple versatile processes are installed to a storage management API library of the storage management server. Further, when the storage management AP is connected to the storage management API providing server program via the storage management API library, the storage management API library acquires an API attribute information from the storage management API providing server program. Then, when the storage management AP executes the function of the storage system via the storage management API library, before and after execution of the function, the storage management API library combines multiple versatile processes according to API attribute information, and the processes are executed by the storage management server.

### TECHNICAL FIELD

The present invention relates to a storage management system, a storage system, and a method for extending function thereof.

### BACKGROUND ART

Recently, along with the increase of data and business software, and the enhancement of the level of technology related to IT platform, such as virtualization, IT systems such as computer systems and storage systems managed by enterprises are becoming more complex year after year. With the aim to facilitate operation of IT systems, various storage management application programs operating in a storage management server are provided from many venders.

When a storage system is managed using such storage management application programs, the storage management application programs are connected via storage management APIs (Application Programming Interfaces) of the storage system. The storage management APIs are extended when a function of a storage system is extended or when a new storage system is released, and along with this change of the storage management API, the respective storage management application programs must also be extended. Patent Literature 1 teaches an art related to this technology.

### CITATION LIST

### Patent Literature

[PTL 1] US Patent Application Publication No. 2002/0161880

### SUMMARY OF INVENTION

### Technical Problem

When the storage management application program of the storage management server is made to correspond to the extension of function of the storage system, it becomes necessary to “add a new processing logic using the extended storage management API” and to “perform re-linkage to the extended storage management API library”. Therefore, it is not possible to correspond to the extension of function by an already released storage management application program. Since a large number of storage management application programs exist, it is difficult to extend the functions in a timely manner.

Regarding the above-described problem, it is possible to provide a means to solve the problem by providing only a display function and an input function to a user operation screen on the side of the storage management application program (management AP), and to provide all the other functions and processes to the side of a storage management API providing server program of the storage system. However, by adopting such means, a plurality of processes of the storage management application programs will be executed collectively in the storage management API providing server program on the storage system side, so that the processing load of the storage system becomes too high. Moreover, in order to execute one function, it becomes necessary to issue a large number of commands and parameters and to receive the result of execution of commands, according to which the transmission and reception of information between the storage management server and the storage system is increased significantly, and the communication load is increased. Therefore, one of the objects of the present invention is to enable the respective storage management application programs to be applied to a function extended in the storage system or to a new storage system, without having to add a processing logic to the respective storage management application program, and without increasing the processing load of the system in which the storage management API providing server program is operated.

### Solution to Problem

In order to solve the above-described problems, according to one preferred embodiment of the present invention, a plurality of versatile processes are equipped to the storage management API library of the storage management server. Moreover, when the storage management application program is connected to the storage management API providing server program via the storage management API library, the storage management API library acquires a storage management API attribute information from the storage management API providing server program. Then, when the storage management application program executes a function of the storage system via the storage management API library, a plurality of versatile processes according to the storage management API attribute information is combined by the storage management API library before and after execution of the function, and the combined function is executed by the storage management application program.

### Advantageous Effects of Invention

According to one preferred embodiment of the present invention, an existing storage management application program can be applied to the extension of function or adding of function in a storage system without having to add a processing logic to each storage management application program and without increasing the load of the storage system. The problems, configurations and effects other than those described above will become clear in the following description of the preferred embodiments.

### BRIEF DESCRIPTION OF DRAWINGS

FIG. 1 is a view showing a concept of the present embodiment.

FIG. 2 is a view showing an overall configuration of a storage management system.

FIG. 3 is a view showing a software configuration of the storage management system.

FIG. 4 is a view showing a configuration example of a first storage management API attribute definition information (createLdev).

FIG. 5 is a view showing a configuration example of a first storage management API attribute information (createLdev).

FIG. 6 is a view showing a configuration example of a second storage management API attribute definition information (addLuPath).

FIG. 7 is a view showing a configuration example of a second storage management API attribute information (addLuPath).

FIG. 8 is a view showing a sequence of operation of a process for generating a storage management API attribute information and for executing an arbitrary function.

FIG. 9 is a flowchart showing a validity check processing of requested data.

FIG. 10 is a flowchart of a validity check processing of an integer member.

FIG. 11 is a flowchart showing a validity check processing of an integer member.

FIG. 12 is a flowchart showing a validity check processing of a character string member.

FIG. 13 is a flowchart showing a validity check processing of a byte array member.

FIG. 14 is a view showing a configuration example of the screen of a management application utilizing a storage management API attribute information.

### DESCRIPTION OF EMBODIMENTS

Now, the preferred embodiments of the present invention will be described with reference to the drawings. In the following description, various information are referred to as “management tables”, for example, but the various information can also be expressed by data structures other than tables. Further, the “management table” can also be referred to as “management information” to indicate that the information does not depend on the data structure.

The processes are sometimes described using the term “program” as the subject. The program is executed by a processor such as an MP (Micro Processor) or a CPU (Central Processing Unit) for performing determined processes. A processor can also be the subject of the processes since the processes are performed using appropriate storage resources (such as memories) and communication interface devices (such as communication ports). The processor can also use dedicated hardware in addition to the CPU. The computer programs can be installed to each computer from a program source. The program source can be provided via a program assignment server or a storage media, for example.

Each element, such as each controller, can be identified via numbers, but other types of identification information such as names can be used as long as they are information capable of identifying the respective elements. The equivalent elements are denoted by the same reference numbers in the drawings and the description of the present invention, but the present invention is not restricted to the present embodiments, and other modified examples in conformity with the idea of the present invention are included in the technical scope of the present invention. The number of each component can be one or more than one, unless defined otherwise.

### <Concept of Invention>

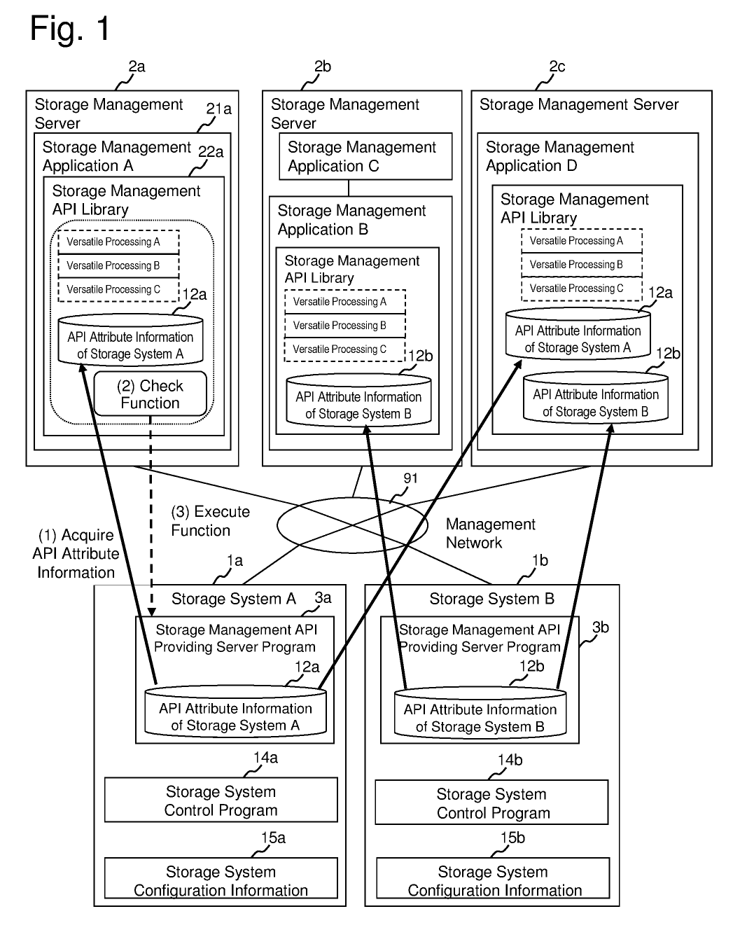

FIG. 1 illustrates a concept of the present embodiment. A storage management system of the present embodiment has a storage system A 1a and a storage system B 1b coupled via a management network 91 to storage management servers 2 (storage management servers 2a/2b/2c), which are operation management systems of the storage system. The storage system A 1a and the storage system B 1b may simply be referred to as storage system 1, and the storage management servers 2a/2b/2c may simply be referred to as storage management server 2.

In the present embodiment, according to the following three operations, (1) acquisition of storage management API attribute information, (2) checking of validity of execution of function, and (3) execution of function, the aforementioned “adding of new logic of processing using an extended storage management API” and “re-linkage to extended storage management API library” become unnecessary. A library is a file having gathered programs for executing versatile processes and functions, which is called for example from OSs or APs to execute predetermined processes (such as communication processing and function calculating processing). Further, a storage management API is an interface program having gathered a plurality of storage management API attribute information showing one function.

### (1) Acquisition of Storage Management API Attribute Information

The storage management server 2 acquires a storage management API attribute information 12a within a storage management API providing server program 3a of the storage system A 1a and a storage management API attribute information 12b within a storage management API providing server program 3b of the storage system B 1b. The storage management API attribute information defines supported function commands, the type of data items required to execute the command, the type of the data items (type: character string, integer and the like), and the attribute of the data items (maximum value, minimum value and the like). The storage management API attribute information is updated by the storage system configuration information 15a/15b. That is, when the configuration of the storage system 1 is changed, the storage management API attribute information is updated by the changed storage system configuration information 15. This storage system configuration information 15 is set when the storage system is initially introduced, and the information is updated each time the system configuration is changed.

For example, the storage management server 2a/2c acquires the storage management API attribute information 12a of the storage system A 1a, and the storage management server 2b/2c acquires the storage management API attribute information 12b of the storage system B 1b. Multiple types of versatile processing programs (versatile processing A/B/C and so on, hereinafter referred to as versatile processing) are installed in advance to a storage management API library, such as storage management API library 22a, of each storage management server. Further, a storage management application program installed in each storage management server executes predetermined processes using the storage management API library.

As described, the storage management server 2a acquires the storage management API attribute information 12a, the storage management server 2b acquires the storage management API attribute information 12b, and the storage management server 2c acquires the storage management API attribute information 12a and storage management API attribute information 12b, which are stored in the storage management API library.

### (2) Validity Check of Execution of Function

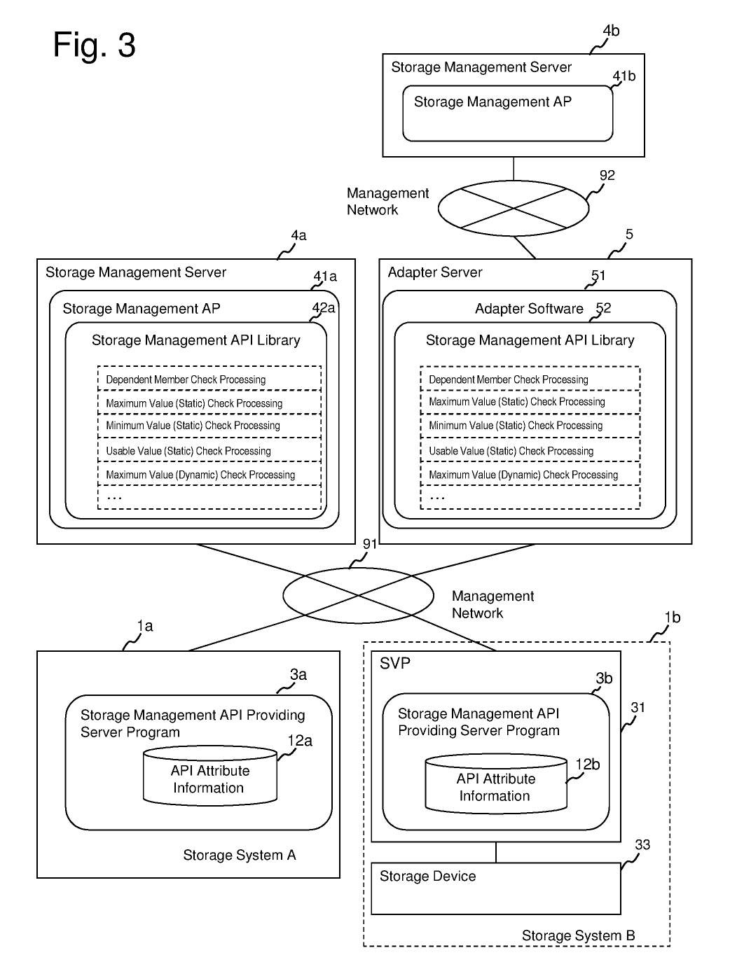

In each storage management server, a validity check of function is carried out based on the storage management API attribute information acquired from the respective storage systems, by combining the versatile processing (versatile processing A/B/C in the drawing, such as the check processing of FIG. 3) implemented in advance in the storage management API library. For example, based on the storage management API attribute information 12a of the storage system A 1a acquired by the storage management server 2a, versatile processing A/B/C and the like are combined to perform a validity check of the execution of function to the storage system A 1a. Similarly, in storage management server 2b, based on the storage management API attribute information 12b, the versatile processing A/B/C and the like are combined to perform a validity check of the execution of function to the storage system B 1b. Similarly, in storage management server 2c, based on the storage management API attribute information 12a or 12b, versatile processing A/B/C and the like are combined to perform a validity check of the execution of function to the storage system A 1a, and to also perform a validity check of the execution of function to the storage system B 1b. The contents of the validity check processing will be described with reference to FIG. 3.

(3) Execution of Function after Completing Validity Check

The storage management server executes a function after completing validity check to the storage system. The storage system having received the order to execute a function executes the designated command by a storage system control program 14. The storage system control program 14 is a program for performing the basic control (such as disk control and system information management) of a system, which is stored in a memory or a disk described later and executed as needed by the CPU. For example, the storage management server 2a executes the function to the storage system A 1a. The storage management server 2c executes the new function to the storage system A 1a or the storage system B 1b. The result of execution in each storage system control program 14 is acquired by the storage management server.

By the above-described operations (1) through (3), it becomes possible to apply the respective storage management application programs to extended functions of the storage system or to a new storage system, without having to add processing logics to each storage management application program and without increasing the load applied on the server program providing the storage management API. The detailed operation thereof will be described later.

### <System Configuration>

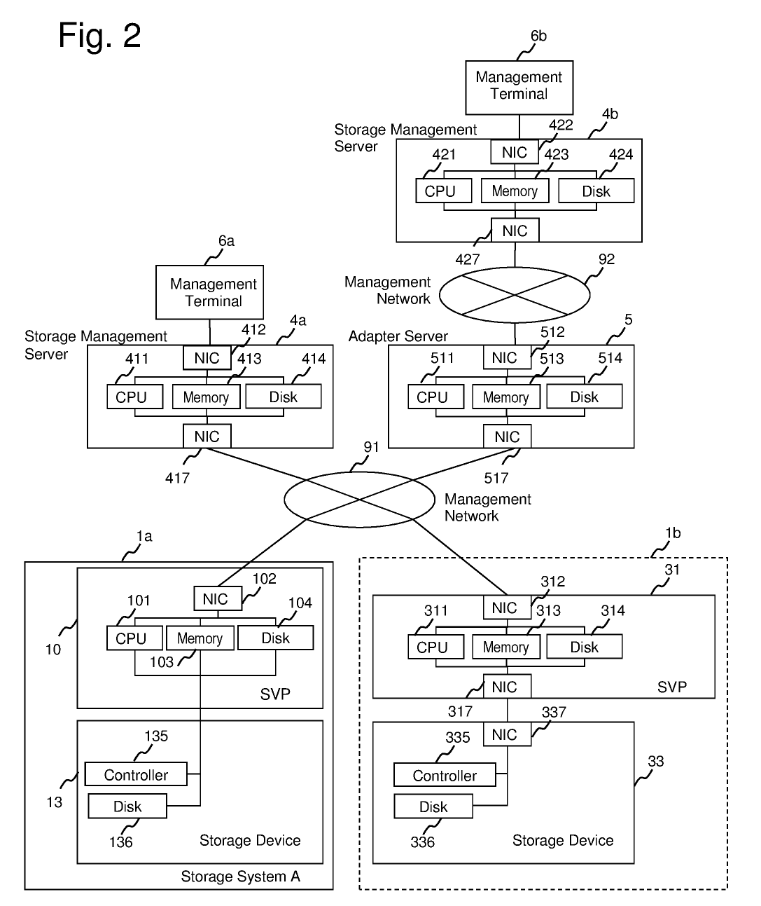

FIG. 2 is a view illustrating an overall configuration of the storage management system. The storage management system is configured to include a storage system and a storage management server. The number of storage systems can be one or more than one. The number of storage management servers can be one or more than one.

The storage management system illustrated in FIG. 2 is equipped with storage systems 1a/1b, storage management servers 4a/4b which are the management system of the storage system 1, management terminals 6a/6b (hereinafter referred to as management terminal 6) for controlling the storage management servers 4a/4b, and an adapter server 5 functioning as a connection system of the storage system 1 and the storage management server 4, wherein the respective systems are connected via management networks 91/92.

The storage system 1a is equipped with an SVP (Service Processor) 10 and a storage device 13.

The SVP 10 is equipped with a CPU 101 for controlling the whole system, an NIC (Network Interface Card) 102 connected to the management network 91 for communicating with the storage management server 4 or the adapter server 5, a volatile memory 103 (hereinafter referred to as memory 103) for temporarily storing control information of the storage system such as a storage system configuration information 20, a disk 104 which is a nonvolatile storage device for permanently storing the control information such as the storage system configuration information 20, and various programs such as a storage management API providing server program 3 and a library. The SVP 10 monitors the configuration and state of the storage device 13, receives management commands from the storage management server 4 or the adapter server 5, and controls the storage device 13. The storage management API providing server program 3 operates in the CPU 101 of the SVP 10, and realizes the aforementioned function for monitoring the configuration and states and the function for receiving management commands.

Further, the storage device 13 is equipped with a disk 136 for permanently storing a large amount of data, and a disk controller (hereinafter referred to as controller) 135 for controlling the disk 136, which communicates user data with a host server (not shown) and stores the user data in the disk 136. The storage system control program 14 is operated in the controller 135 and realizes the aforementioned function to communicate user data and the function to store user data.

The storage device 13 and the SVP 10 can be provided in a same chassis, or in different chassis which are connected via a network or a communication line.

The storage system 1b is composed of an SVP 31 and a storage device 33. Similar to the SVP 10 of the storage system 1a, the SVP 31 is equipped with a CPU 311, an NIC 312, a memory 313 and a disk 314, and is further equipped with an NIC 317 for communicating with the storage device 33. The SVP 31 monitors the configuration and state of the storage device 33, receives management commands from the storage management server 4 or the adapter server 5, and controls the storage device 33. The storage management API providing server program 3 operates in the CPU 311 of the SVP 31, and realizes the aforementioned function to monitor the configuration and state and the function to receive management commands.

The storage device 33 is equipped with an NIC 337 for communicating with a disk 336, a controller 335, and an NIC 337 for communicating with the SVP 31, which communicates user data with a host server (not shown) and stores user data in the disk 336. The storage system control program 14 operates in the controller 335, and realizes the aforementioned function to communicate user data and the function to store user data.

The storage device 33 and the SVP 31 can be provided in the same chassis, or can be provided in different chassis and connected via a network. Further, it is possible to connect one or more storage devices 33 to the SVP 31.

The storage management server 4 is equipped with a CPU 411, a memory 413, a disk 414 and NICs 412/417, which is coupled via a network to one or a plurality of storage systems 1, and provides a user interface for operating the storage system 1 and/or APIs for enabling a different storage management server 4 to operate the storage system 1. The storage management server providing APIs to another storage management server 4 may specifically be called an adapter server 5. A storage management application operates in the CPU 411 of the storage management server 4, and realizes the aforementioned user interface function or the API providing function.

The adapter server 5 is equipped with a CPU 511, a memory 513, a disk 514 and NICs 512/517.

Although not illustrated, a management terminal 6 is also equipped with a similar hardware configuration as the storage management server 4, and is further equipped with an information input device such as a keyboard and a mouse, and a display device such as a liquid crystal display. The configuration of the respective systems are not necessarily the same, and each system can be equipped with an information input device or a display device similarly as the management terminal 6.

### <Software Configuration>

FIG. 3 is a view showing a software configuration of the storage management system. As the software of the storage system 1a, the storage management API providing server program 3a is stored in the disk 104 or the disk 136 of the storage system 1a, and read into the memory 103 as needed by the CPU 101 or the controller 135 for execution. The storage management API attribute information 12a is managed by the storage management API providing server program 3a. Similar to the storage system 1a, as the software of the storage system 1b, the storage management API providing server program 3b is stored in the disk 314 or the disk 336 of the storage system 1b, and read into the memory 313 as needed by the CPU 311 or the controller 335 for execution. Further, the storage management API attribute information 12b is managed by the storage management API providing server program 3b.

The storage management API attribute information 12a is stored in the disk 104 or the disk 136, read into the memory 103 as needed by the CPU 101 or the controller 135, and provided through a network 91 coupled via the NIC 102 to the storage management server 4 or the adapter server 5.

Moreover, the storage management API attribute information 12b is stored in the disk 314 or the disk 336, read into the memory 313 as needed by the CPU 311 or the controller 335, and provided through the network 91 coupled via the NIC 312 to the storage management server 4 or the adapter server 5.

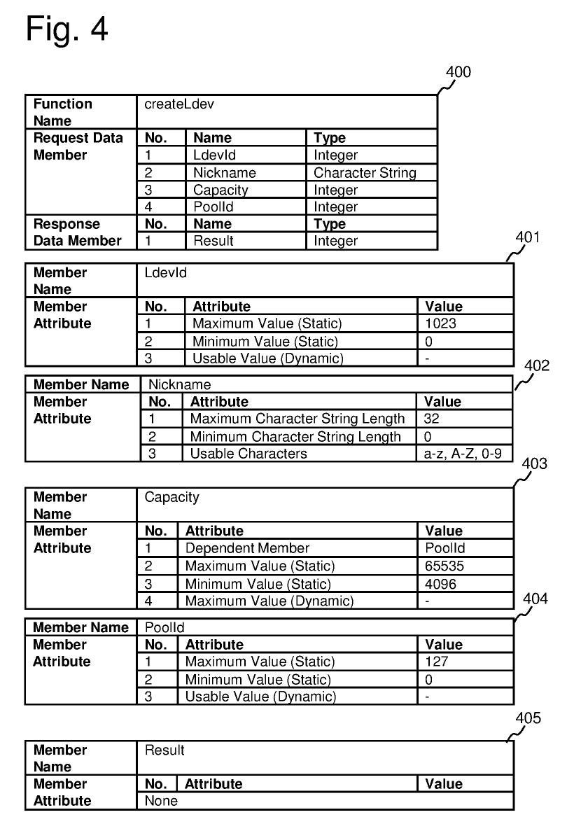

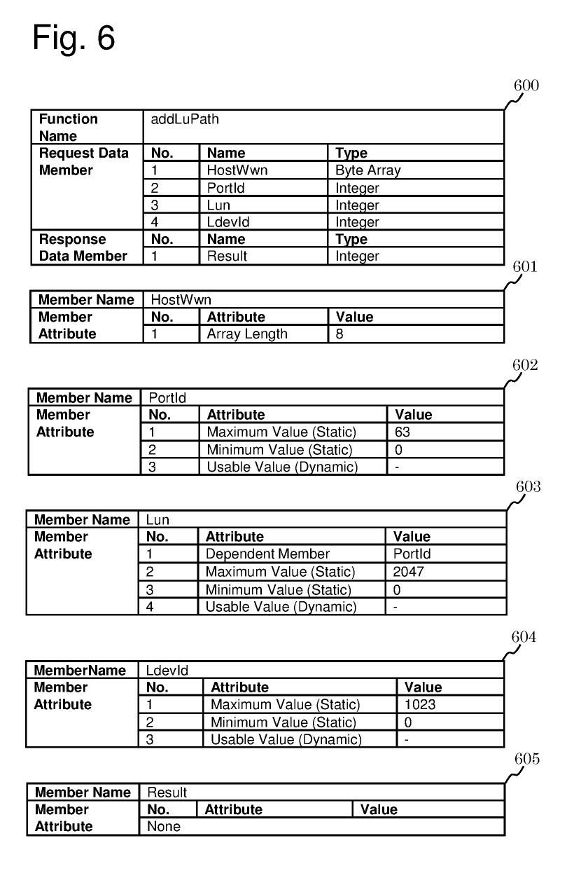

Although not shown, a storage management API attribute definition information (refer to FIG. 4 or FIG. 6) for generating the storage management API attribute information 12b is also stored in the disk 314 or the disk 336. The storage management API attribute definition information is read into the memory 313 as needed from the disk 314 or the disk 336 by the CPU 311 or the controller 335, and based on the similarly read storage system configuration information 15a of the storage system 1a, the storage management API attribute information 12a is generated. The storage management API attribute information 12b is similar to the storage management API attribute information 12a. The detailed operation thereof will be described later.

A storage management application program (management AP) 41a is a software of the storage management server 4a. As described, the storage management AP 41a is a software that executes a predetermined function using the storage management API attribute information 12a of the storage system 1a or the storage management API attribute information 12b of the storage system 1b and a storage management API library 42a to the storage system 1a or the storage system 1b by the CPU 411. The storage management AP 41a is stored in the disk 414, read as needed by the CPU 411 into the memory 413 and executed. The storage management API library 42a is also stored in the disk 414, read as needed by the CPU 411 into the memory 413 and used when executing the storage management AP 41a. Further, the storage management API attribute information 12 acquired from the storage system 1 is temporarily stored in the disk 414, read as needed by the CPU 411 into the memory 413, and used when executing the storage management AP 41a.

A storage management AP 41b is a software of the storage management server 4b. Similar to the storage management AP 41a, the storage management AP 41b is a software that executes a predetermined function to the storage system 1a or the storage system 1b by the CPU 421 using the storage management API attribute information and the storage management API library, which is stored in a disk 424, and read to a memory 423 to be executed.

An adapter program (hereinafter referred to as adapter) 51 is a software of the adapter server 5 that functions as an adapter when the storage management AP 41b of the storage management server 4b executes functions for the storage system 1a or the storage system 1b. The adapter 51 is a software that executes via the CPU 511 the functions responding to the request from the storage management AP 41b of the storage management server 4b to the storage system 1a or the storage system 1b, using the storage management API attribute information 12a of the storage system 1a or the storage management API attribute information 12b of the storage system 1b and the storage management API library 52. By the adapter 51 of the adapter server 5, the installation of the storage management API library and the acquisition of storage management API attribute information are unnecessary in the storage management server 4b. This adapter 51 is stored in the disk 514, and when the storage management AP 41b operates in the CPU 421, it is read by the CPU 511 from the disk 514 into the memory 513 and executed. Further, the storage management API library 52 and the storage management API attribute information 12 are stored in the disk 514, and when the storage management AP 41b is operated in the CPU 421, they are read by the CPU 511 into the memory 513 as needed and executed.

Various versatile processing, such as a dependent member check processing, a maximum value (static) check processing, a minimum value (static) check processing, a usable value (static) check processing, a maximum value (dynamic) check processing, a minimum value (dynamic) check processing or an usable value (dynamic) check processing, are stored and installed in advance as versatile processing to the storage management API library 42a or the storage management API library 52. Versatile processing is not restricted to check processing, and processes such as displaying the result of the check processing using an error code or converting the error code into an error message can also be added.

The storage management server 4/adapter server 5 is capable of acquiring a plurality of types of storage management API attribute information from a plurality of storage management API providing server programs Therefore, the storage management server 4/adapter server 5 can manage different storage systems by using one storage management API library. Further, the versatile processing installed in the storage management API library can be added by enhancement.

### <Storage Management API Attribute Definition Information 1>

FIG. 4 is a view showing a configuration example of a first storage management API attribute definition information. The storage management API attribute definition information is an attribute information defining the contents of a function and necessary parameters (set values), which is a basic information of the storage management API attribute information. Storage management API attribute definition information 400 illustrated in FIG. 4 shows an example of a createLdev function (LDEV creating function). The CPU 101 acquires this storage management API attribute definition information 400 from the memory 103 or the disk 104/136 of the storage system 1a when the storage management API providing server program 3 is activated (starts operation). In the case of the storage system 1b, the CPU 311 acquires the storage management API attribute definition information from the memory 313 or the disk 314/336.

The storage management API attribute definition information 400 has a function name “createLdev”, and has four members of requested data, the names (member names) of which are “LdevId”, “Nickname”, “Capacity” and “PoolId”, and the corresponding types are “integer”, “character string”, “integer” and “integer”, respectively. Further, there is one member of response data with respect to the requested data, the name of which is “Result” and the type thereof is “integer”.

The storage management API attribute definition information respectively corresponding to request data members “LdevId”, “Nickname”, “Capacity” and “PoolId” are denoted by reference numbers 401 through 404, and the storage management API attribute definition information corresponding to response data “Result” is denoted by reference number 405.

There are three member attributes of storage management API attribute definition information 401 (member name: “LdevId”), which are “maximum value (static), “minimum value (static)” and “usable value (dynamic)”, each value being set by an integer. The values of “maximum value (static)” and “minimum value (static)” are set by the information of the files stored in the memory 103/313 and the disk 104/314 or the disk 136/336 when the storage management API providing server program is started. The attribute “usable value (dynamic)” is set when the storage management API providing server program 3 acquires the storage system configuration information 15 of the storage system 1.

There are three member attributes of the storage management API attribute definition information 402 (member name: “Nickname”), which are “maximum character string length”, “minimum character string length” and “usable characters”, wherein “maximum character string length” is set to an integer of 32, “minimum character string length” is set to an integer of 0, and “usable characters” are set by a character string designated by “a-z, A-Z and 0-9”.

The attribute of the member of storage management API attribute definition information 403 (member name: “Capacity”) are “dependent member”, “maximum value (static)”, “minimum value (static)” and “maximum value (dynamic)”. The “dependent member” is information for acquiring the contents of the storage management API attribute definition information 404 whose member name is “PoolId”. Similar to the aforementioned attribute “usable value (dynamic)”, the attribute “maximum value (dynamic)” is set when the storage management API providing server program 3 acquires the storage system configuration information 15 of the storage system 1.

The attribute of the member of the storage management API attribute definition information 404 (member name: “PoolId”) is similar to the storage management API attribute definition information 401. There is no member attribute of the storage management API attribute definition information 405, and shows that the result of having executed the function name “createLdev” is stored as integer with a member name Result to the response data. The stored value of the Result of response data is set so as to enable the executed result to be determined, for example by setting value “0” to show normal operation and value other than “0” to show abnormal end.

The requested data or response data member can be added to the storage management API attribute definition information by enhancement of the storage system (enhancement: extension of function, addition of new function and the like). The member type can be changed by enhancement. The member attribute can also be added by enhancement to the storage management API attribute definition information. The value of the member attribute can be changed by enhancement.

### <Storage Management API Attribute Information 1>

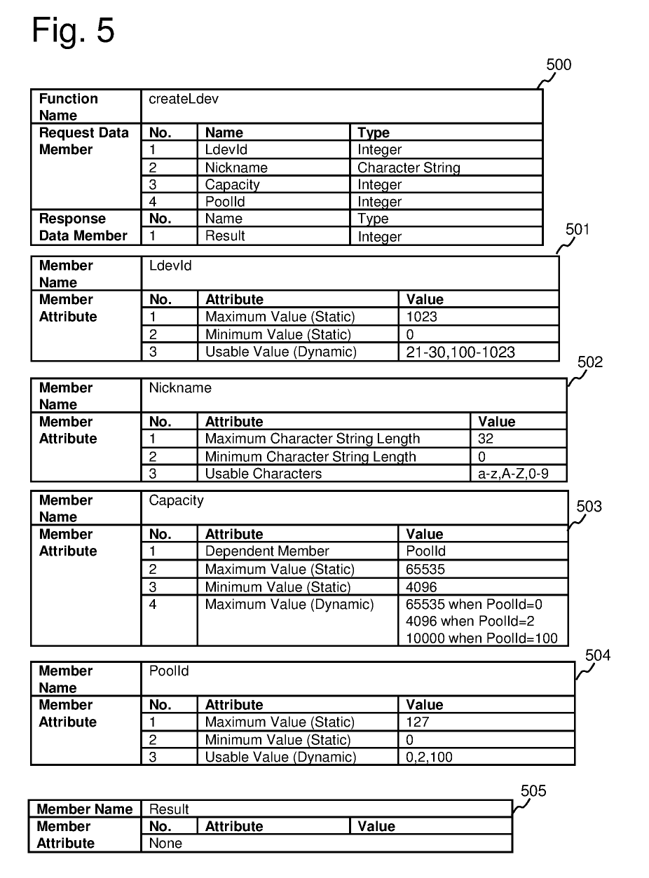

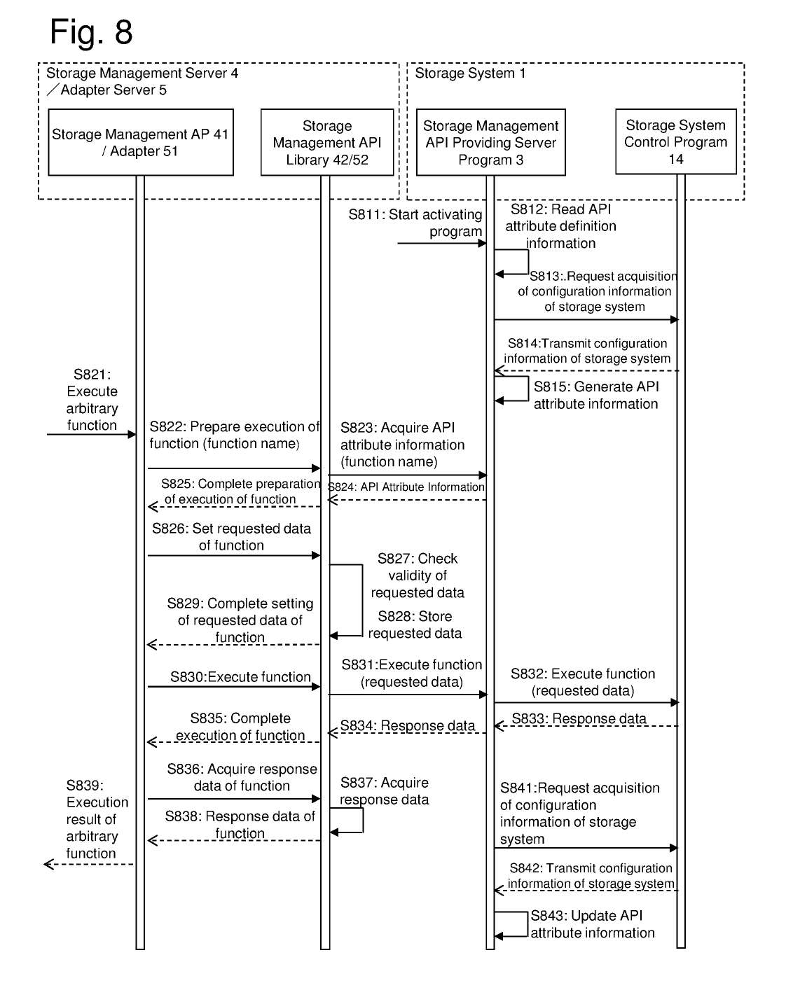

FIG. 5 is a view showing a configuration example of the first storage management API attribute information (createLdev). In the process of S815 described later with respect to FIG. 8, dynamic information is stored in the storage management API attribute definition information 400 based on the system information of the storage system 1, to thereby generate a storage management API attribute information 500.

In attribute “usable value (dynamic)” of storage management API attribute information 501 (member name: “LdevId”), “21-30” and “100-1023” are stored from the acquired system information of the storage system 1. In other words, it means that LdevId “21-30” and “100-1023” are not used, and LDEVs having these numbers can be generated.

In attribute “usable value (dynamic)” of storage management API attribute information 504 (member name: “PoolId”), “0, 2, 100” is stored from the acquired information. In other words, it shows that pools having Pool IDs “0”, “2” and “100” are generated pools, and can be used. The present information is transmitted as arguments to storage management API attribute information 503 (member name: “Capacity”). In other words, in attribute “maximum value (dynamic)” of storage management API attribute information 503, the “PoolId” information is cited, showing that “maximum value (dynamic) is 65535 when “PoolId=0”, “maximum value (dynamic) is 4096 when PoolId=2”, and “maximum value (dynamic) is 10000 when PoolId=100”.

In the present embodiment, for example, in storage management API attribute definition information having a function name “createLdev”, it is assumed that it has no member name “Nickname” (type: “integer”) in the storage management API prior to being extended, but the member name “Nickname” (type: “integer”) is supported in the storage management API after being extended. It is necessary to enable the function whose member name in the storage management API after being extended is “Nickname” (type: “integer”) to be executed on the management application side. Therefore, when the storage management API providing server program 3 of the storage system 1 receives the execution request of this “createLdev” function, it sends the storage management API attribute information generated from the storage management API attribute definition information after the function has been extended to the storage management API library on the management application side, and the storage management API library stores and retains the received storage management API attribute information in the interior thereof. Whether the information set for the “createLdev” function is appropriate or not is determined by a validity check processing, which is a versatile processing, so as to enable the execution of the extended functions. The detailed operation of the validity check processing will be described with reference to FIG. 8 and subsequent drawings.

### <Storage Management API Attribute Definition Information 2>

FIG. 6 is a view illustrating a configuration example of a second storage management API attribute definition information (addLuPath). FIG. 6 illustrates an example of an addLuPath function (function to add LU path) in a storage management API attribute definition information 600. Similar to the storage management API attribute definition information 400, the storage management API attribute definition information 600 is also acquired by the CPU 101 from the memory 103 or the disk 104/136 of the storage system 1a when the storage management API providing server program 3 is activated (starts operation). In the case of storage system 1b, the CPU 311 acquires the storage management API attribute definition information from the memory 313 or the disk 314/336.

In storage management API attribute definition information 600, the function name is “addLuPath”, the number of requested data members is four, the names thereof (member names) are “HostWwn”, “PortId”, “Lun” and “LdevId” and the corresponding types are “byte array”, “integer”, “integer” and “integer”, respectively. Further, there is one response data member with respect to the requested data, whose name is “Result” and the type is “integer”.

The storage management API attribute definition information corresponding to each requested data member “HostWwn”, “PortId”, “Lun” and “LdevId” are denoted by reference numbers 601 through 604, and the storage management API attribute definition information corresponding to response data member “Result” is denoted by reference number 605.

The member attribute of storage management API attribute definition information 601 (member name: “HostWwn”) is “array length”, and it is defined by eight-byte information. The member attribute of storage management API attribute definition information 603 (member name: “Lun”) are “dependent member”, “maximum value (static)”, “minimum value (static)” and “usable value (dynamic)”. The “dependent member” information is for acquiring the contents of the storage management API attribute definition information 602 whose member name is “PortId”. The storage management API attribute definition information 602 (member name: “PortId”) and storage management API attribute definition information 604 (member name: “LdevId”) have a similar configuration as the aforementioned storage management API attribute definition information 401 (member name: “LdevId”) and storage management API attribute definition information 404 (member name: “PoolId”).

Incidentally, the member of requested data or response data and member attribute can be added to the storage management API attribute definition information by enhancement, and the value of member attribute can also be changed in the storage management API attribute definition information by enhancement. The member type can also be added to the storage management API attribute definition information by enhancement.

### <Storage Management API Attribute Information 2>

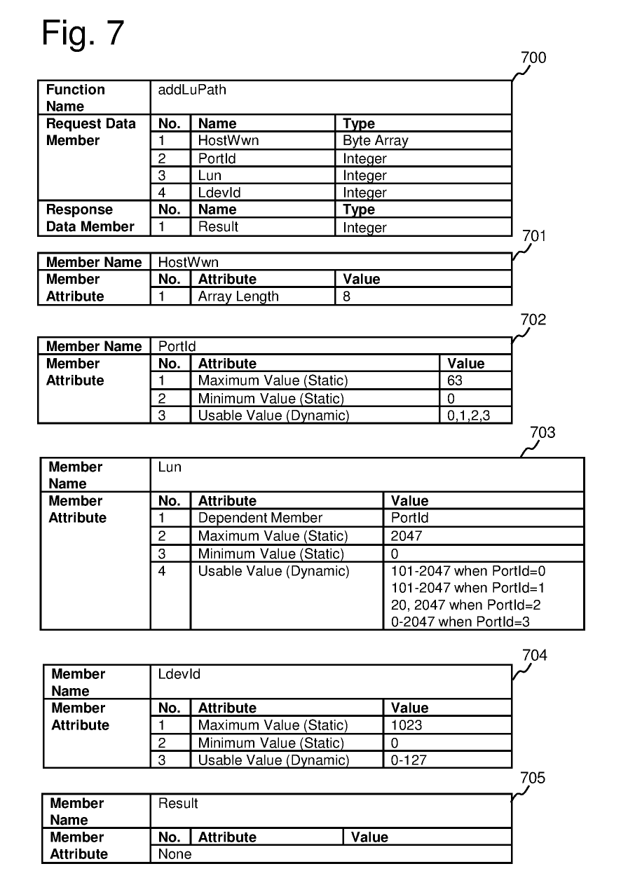

FIG. 7 is a view showing a configuration example of a second storage management API attribute information (addLuPath). In S815 of FIG. 8, dynamic information is stored in the storage management API attribute definition information based on the storage system information, so as to generate the present storage management API attribute information.

Also according to the present example, similar to FIG. 5, “0, 1, 2, 3” is stored in attribute “usable value (dynamic)” of storage management API attribute information 702 (member name: “PortId”) from the acquired information, so that it can be recognized that ports numbered 0 to 3 are available. Storage management API attribute information 703 (member name: “Lun”) and storage management API attribute information 704 (member name: “LdevId”) are also similar to the storage management API attribute information 702 (member name: “PortId”). The aforementioned storage management API attribute definition information and storage management API attribute information have been described based on functions whose function names are “createLdev” (create LDEV) and “addLuPath” (add LUN path), but are not restricted to such functions, and the function can be volume capacity extension, differential data save (execute snapshot), volume type change, and so on. Furthermore, the present embodiment has been described taking as an example the adding of a member to an existing function, but as a command related to volume, an effect similar to adding a member can be achieved, by adding a new command called “volume delete”, which is a new function that differs from the aforementioned LDEV generation and volume capacity extension, and combining the same with the versatile processing.

### <Operation Sequence>

FIG. 8 is a view showing a sequence of operation of a process for generating a storage management API attribute information, and an operation for executing an optional function. The subject of the processes is the respective software or system, but it can also be the storage system 1, the storage management server 4 or the adapter server 5 alone, or the CPU of each system.

In S811, the storage management API providing server program 3 operating in the CPU 101/311 of the storage system 1 activates itself by a program activation command. The program activation command is issued either periodically via a scheduler, or when a configuration or function of the storage system 1 is added or changed.

In S812, the storage management API providing server program 3 reads the storage management API attribute definition information stored in the memory 103/313 or the disk 104/314 of the storage system 1.

In S813, the storage management API providing server program 3 issues a command for acquiring the storage system configuration information 15 (such as the generation state information of volume, the generation/use state information of storage pool, the connection port information with respect to superior systems, and so on) of the storage system 1 to the storage system control program 14. It is also possible to have the storage system configuration information 15 of the storage system 1 stored in advance in the memory 103/313 or the disk 104/314 of the storage system 1, and have the same acquired by the storage management API providing server program 3.

In S814, the storage system control program 14 having received the acquisition command reads the storage system configuration information 15 of the storage system 1 stored in the memory 103/313 or the disk 104/314, and transmits the same to the storage management API providing server program 3. The storage management API providing server program 3 stores the acquired storage system configuration information 15 in the storage area of the memory 103/313 or the disk 104/disk 314 managed by the storage management API providing server program 3.

In S815, the storage management API providing server program 3 updates the storage management API attribute definition information (such as the storage management API attribute definition information 400) by the storage system configuration information 15 acquired in S814, and generates a storage management API attribute information (such as the storage management API attribute information 500). Then, the storage management API providing server program 3 stores the generated storage management API attribute information in the memory 103/313 or the disk 104/314. It executes the process of S815 to all functions supported by the storage management APIs.

By the processes S811 through S815, the storage management API providing server program 3 can generate the newest storage management API attribute information. The process of S812 can be read from the file not only when the server starts operating, but also periodically via a scheduler, or when installing an extended API. The same applies for the generation of storage management API attribute information from S813 to S815. The storage management API attribute information of the corresponding function or all functions can be updated by the request to execute function from the storage management AP 41 or the adapter 51.

In S821, the storage management AP 41 operating in the storage management server 4 (CPU 411) or the adapter 51 operating in the adapter server 5 (CPU 511) receives commands for executing an arbitrary function from the system administrator. When the system operation administrator enters a command to execute a given process using an input device of the management terminal 6, and the command is received by the management terminal 6 and transferred to the storage management server 4 or the adapter server 5, the storage management server 4 (CPU 411) or the adapter server 5 (CPU 511) starts the process of S821.

In S822, the storage management AP 41/adapter 51 having receive the command to execute an arbitrary function prepares execution of the function having the function name designated by that command. That is, the storage management server 4 (CPU 411)/adapter server 5 (CPU 511) in which the storage management AP 41/adapter 51 operates requests acquisition of storage management API attribute information corresponding to the function name via the storage management API library 42/52 to the storage management API providing server program 3.

In S823, the storage management server 4 (CPU 411)/adapter server 5 (CPU 511) requests acquisition of the storage management API attribute information corresponding to the function name from the storage management API providing server program 3. For example, in order to execute the LDEV generation function, it acquires the storage management API attribute information 500 through 504 as shown in FIG. 5.

In S824, the storage management API providing server program 3 transmits a storage management API attribute information corresponding to the function name to the storage management server 4 (CPU 411)/adapter server 5 (CPU 511). The storage management server 4 (CPU 411)/adapter server 5 (CPU 511) assembles the received storage management API attribute information to the storage management API library 42/52. The storage management API library 42/52 having the storage management API attribute information assembled thereto is stored and retained in the memory 413/513 or the disk 414/514 by the storage management server 4 (CPU 411)/adapter server 5 (CPU 511).

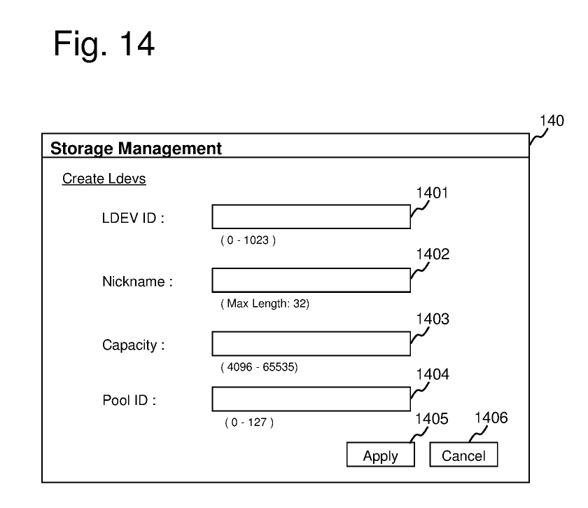

In S825, after assembling the storage management API attribute information corresponding to the function name to the storage management API library 42/52, the storage management server 4 (CPU 411)/adapter server 5 (CPU 511) notifies completion of preparation for executing the function to the storage management AP 41/adapter 51. As described earlier, if there is no member name “Nickname” (type: “integer”) in the storage management API prior to extension, and the member name “Nickname” is supported in the storage management API after extension, it is possible to display and enter member name “Nickname” and type (set the requested data), as shown in FIG. 14.

In S826, the storage management AP 41/adapter 51 sets the requested data of the function, and transmits the same to the storage management API library 42/52. The setting of the requested data of the function is performed using a management application screen illustrated in FIG. 14. Examples of the requested data being set are the storage management API attribute information 500 through 504 illustrated in FIG. 5. Validity check of checking whether there is no problem in the requested data being set is performed by the storage management server 4 (CPU 411)/adapter server 5 (CPU 511) in S827.

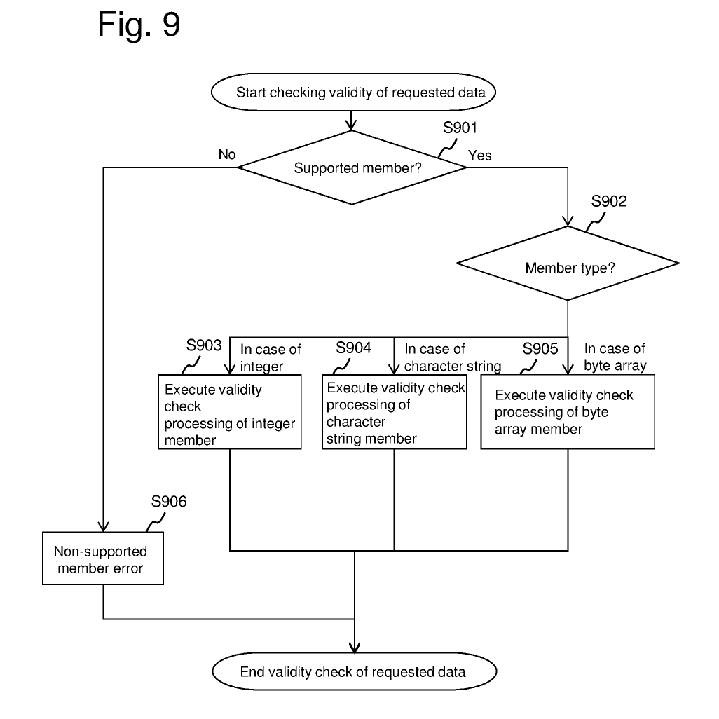

In S827, when the storage management API library 42/52 receives the requested data, the storage management server 4 (CPU 411)/adapter server 5 (CPU 511) performs validity check of requested data via the versatile processing equipped in advance in the storage management API library 42/52. The validity check confirms the support member, the type thereof and the attribute thereof, the details of which will be described with reference to FIGS. 9 through 13. If there is no problem found by the validity check, the storage management server 4 (CPU 411)/adapter server 5 (CPU 511) executes S828 using the versatile processing supported by the storage management API library 42/52, but if there is a problem, it sends an error report to the storage management AP 41/adapter 51.

In S828, the storage management server 4 (CPU 411)/adapter server 5 (CPU 511) stores requested data in a storage area (memory 103/313 or disk 104/314) managed by the storage management API library 42/52 so as to retain the requested data as argument of the designated command in the storage management API library 42/52.

In S829, the storage management server 4 (CPU 411)/adapter server 5 (CPU 511) notifies the storage management AP 41/adapter 51 that the setting of requested data of the function to the storage management API library 42/52 has been completed.

In S830, the storage management AP 41/adapter 51 having received the notice of completion of setting of requested data of the function requests the execution of the designated function via the storage management API library 42/52 to the storage management API providing server program 3.

In S831, the storage management server 4 (CPU 411)/adapter server 5 (CPU 511) transmits the order of execution of function together with the requested data to the storage management API providing server program 3 via the storage management API library 42/52 having received the request of execution of function.

In S832, the storage management API providing server program 3 transmits the command of execution of function having the requested data added thereto to the storage system control program 14. Then, the storage system control program 14 executes the received function together with the requested data, and stores the execution result to the storage area of the memory 103/313 or the disk 104/314 that it manages.

In S833, the storage system control program 14 transmits the aforementioned execution result as response data to the storage management API providing server program 3.

In S834, the storage management API providing server program 3 transmits the response data to the storage management server 4 (CPU 411)/adapter server 5 (CPU 511). For example, the attributes and values of the response data members of the storage management API attribute information 500 and the response data members of the storage management API attribute information 505 correspond to this response data. The storage management server 4 (CPU 411)/adapter server 5 (CPU 511) assembles the received response data to the storage management API library 42/52. The storage management API library 42/52 having the response data assembled thereto is stored and retained by the storage management server 4 (CPU 411)/adapter server 5 (CPU 511) in the memory 413/513 or the disk 414/514.

In S835, after completing storage of the response data to the storage management API library 42/52, the storage management server 4 (CPU 411)/adapter server 5 (CPU 511) transmits a completion notice of execution of function to the storage management AP 41/adapter 51.

In S836, the storage management AP 41/adapter 51 having confirmed completion of execution of function transmits a response data acquisition request of function to the storage management API library 42/52.

In S837, the storage management server 4 (CPU 411)/adapter server 5 (CPU 511) having received the response data acquisition request of function via the storage management API library 42/52 reads the response data being stored and retained in the memory 413/513 or the disk 414/514, and acquires the same.

In S838, the storage management server 4 (CPU 411)/adapter server 5 (CPU 511) transmits the acquired response data to the storage management AP 41/adapter 51.

In S839, the storage management AP 41/adapter 51 transfers the acquired response data to the management terminal 6, displays the result of execution of the arbitrary function on a display device and the like, and notifies the result of execution of the requested function to the system administrator.

The processes of S841 through S843 are the same as the processes of S813 through S815. The processes of S841 through S843 are executed either periodically (when a given time has been reached) using a scheduler or the like, or when there is an addition or change in the configuration or the function of the storage system 1 (such as when the storage management API attribute definition information is updated, or when the storage system configuration information 15 of the storage system 1 is updated). Moreover, it is possible to acquire the storage management API attribute definition information and the storage system configuration information 15 of the storage system 1 and to generate the storage management API attribute information each time the storage management API providing server program 3 is accessed.

As described above, when executing an arbitrary function, by acquiring a storage management API attribute information, setting the requested data corresponding to the function, and checking the validity thereof, it becomes possible to execute the extended function in the storage system 1 without having to enhance the application on the management side. The versatile processing of the present embodiment is not restricted to the validity check processing, and for example, it can be a process of detecting whether there is difference between the storage management API attribute information already stored in the storage management API library 52 and the acquired storage management API attribute information, or a process of detecting an added member or the change of attribute, type, value and the like, and these processes can be installed in advance in the storage management API library 42/52. Further, the versatile processing can be for changing the integer value of response data (value showing the content of result of executing a command) to a message that can easily be understood by the system administrator managing the operation of the storage management server or the storage system 1.

### <Validity Check Processing of Requested Data>

FIG. 9 is a flowchart showing a validity check processing of requested data. The present processing is executed by the storage management server 4 (CPU 411)/adapter server 5 (CPU 511) using the versatile processing installed in the storage management API library 42/52. The validity check of requested data is started by the storage management server 4 (CPU 411)/adapter server 5 (CPU 511) executing the process of S827 of the storage management API library 42/52. A storage management API attribute information 500 (function name: “createLdev”/requested data member: “LdevId”, “Nickname”, “Capacity”, “PoolId”/corresponding type: “integer”, “character string”, “integer”, “integer”) is described as an example.

In S901, the storage management server 4 (CPU 411)/adapter server 5 (CPU 511) determines whether or not the member is supported by the function name (“createLdev”). If the member of the requested data is “LdevId”, “Nickname”, “Capacity”, or “PoolId” (S901: Yes), it executes S902, and if the member is other than the above, it executes S906.

In S902, the storage management server 4 (CPU 411)/adapter server 5 (CPU 511) judges the type of the member. It executes S903 if the type of the member is “integer”, executes S904 if it is “character string”, and executes S905 if it is “byte array”. For example, the storage management server 4 (CPU 411)/adapter server 5 (CPU 511) executes S903 for member “LdevId” since the type thereof is “integer”, executes S904 for member “Nickname” since the type thereof is “character string”, and executes S905 for member “HostWwn” of requested data of storage management API attribute information 700 since the type thereof is “byte array”.

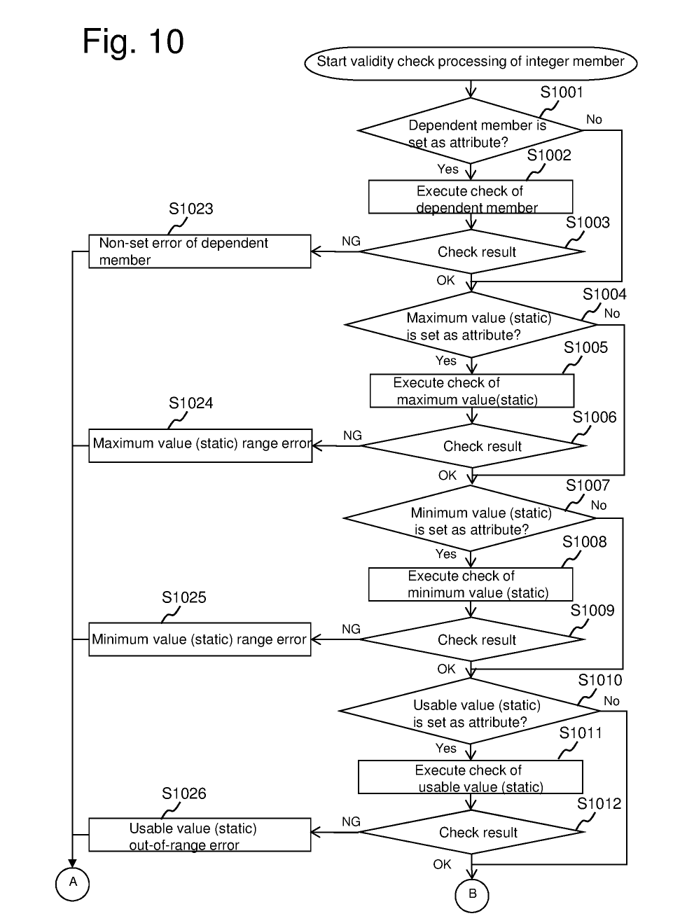

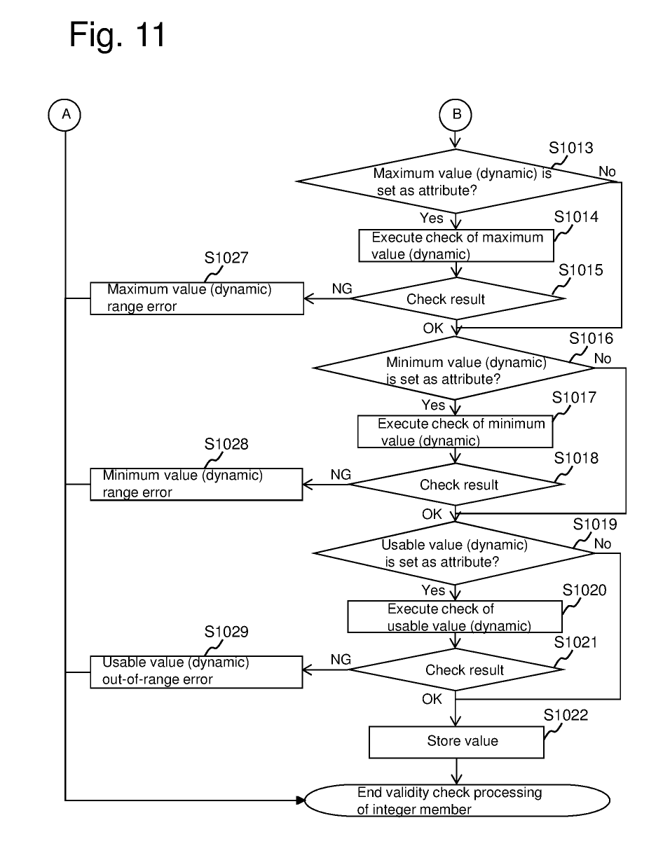

In S903, the storage management server 4 (CPU 411)/adapter server 5 (CPU 511) executes a validity check processing of the integer member (FIGS. 10 and 11), and acquires the check result (response data) thereof.

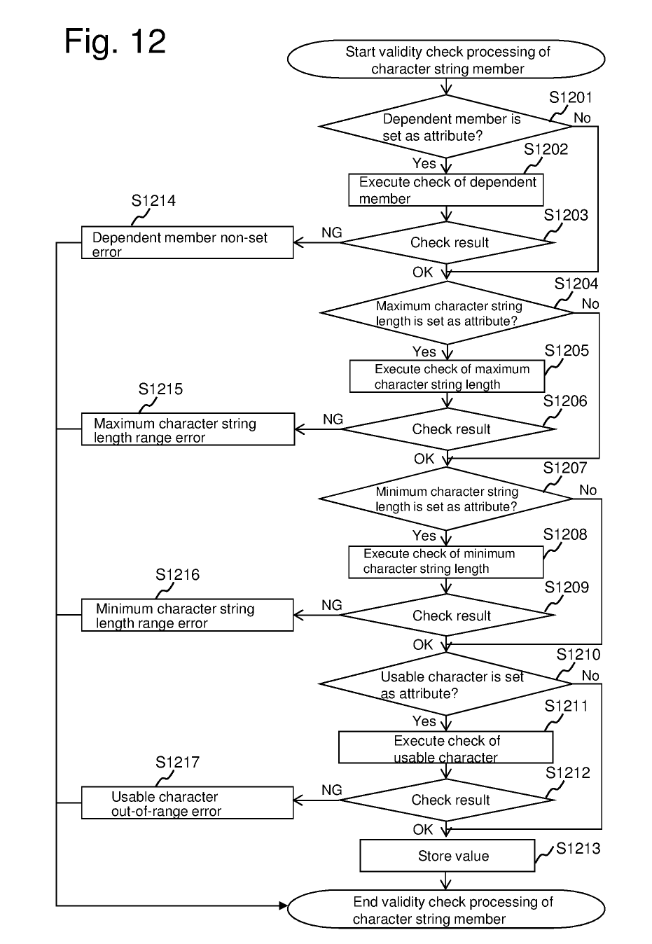

In S904, the storage management server 4 (CPU 411)/adapter server 5 (CPU 511) executes a validity check processing (FIG. 12) of the character string member, and acquires the check result (response data) thereof.

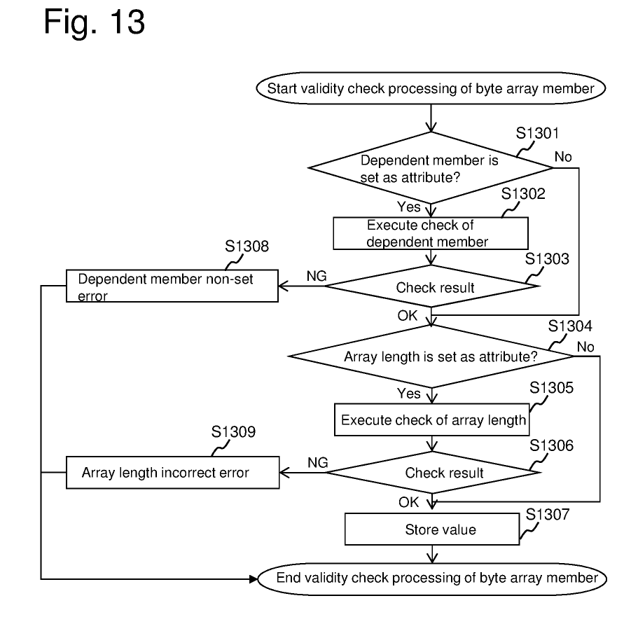

In S905, the storage management server 4 (CPU 411)/adapter server 5 (CPU 511) executes a validity check processing (FIG. 13) of the byte array member, and acquires the check result (response data) thereof.

In S906, the storage management server 4 (CPU 411)/adapter server 5 (CPU 511) determines that the member is not the supported member, and notifies a non-supported member error to the storage management AP 41/adapter 51. Thereafter, the storage management server 4 (CPU 411)/adapter server 5 (CPU 511) ends the validity check of requested data. By the above-described process, it becomes possible to determine whether the requested data is appropriate or not, and generate the determined result (check result) as response data. Each of the processes of S901 and S903 through S305 are examples of versatile processing.

### <Validity Check Processing of Integer Member>

FIGS. 10 and 11 are flowcharts showing the validity check processing of the integer member. The validity of requested data is verified by the validity check processing of the integer member. The present processing is carried out by the storage management server 4 (CPU 411)/adapter server 5 (CPU 511) executing the versatile processing provided in the storage management API library 42/52.

In S1001, the storage management server 4 (CPU 411)/adapter server 5 (CPU 511) judges whether a dependent member is set as the attribute or not. If it is set (S1001: Yes), the storage management server 4 (CPU 411)/adapter server 5 (CPU 511) executes S1002, and if not set (S1001: No), it executes S1004. For example, “PoolId” is set as the dependent member in the storage management API attribute information 503. Similarly, “PortId” is set as the dependent member in the storage management API attribute information 703.

In S1002, the storage management server 4 (CPU 411)/adapter server 5 (CPU 511) executes a check of the dependent member. That is, the storage management server 4 (CPU 411)/adapter server 5 (CPU 511) judges whether an appropriate member value is set as the dependent member. For example, since “PoolId” is set as the dependent member in the storage management API attribute information 503, whether an appropriate value is set in the PoolId or not is checked before setting the value of Capacity. The storage management server 4 (CPU 411)/adapter server 5 (CPU 511) sets the check result to “OK” when an appropriate member value is set, and to “NG” when not set.

In S1003, the storage management server 4 (CPU 411)/adapter server 5 (CPU 511) executes S1004 if the check result of the dependent member is “OK”, and executes S1023 if the result is “NG”. In S1023, the storage management server 4 (CPU 411)/adapter server 5 (CPU 511) notifies a dependent member non-set error to the storage management AP 41/adapter 51.

In S1004, the storage management server 4 (CPU 411)/adapter server 5 (CPU 511) judges whether a maximum value (static) is set as the attribute. If set (S1004: Yes), the storage management server 4 (CPU 411)/adapter server 5 (CPU 511) executes S1005, and if not (S1004: No), it executes S1007. For example, a maximum value (static) is set as attribute in storage management API attribute information 503 through 702.

In S1005, the storage management server 4 (CPU 411)/adapter server 5 (CPU 511) executes a check of the maximum value (static). That is, the storage management server 4 (CPU 411)/adapter server 5 (CPU 511) judges whether the set value is equal to or below a maximum value (static). If the set value exceeds the maximum value, the storage management server 4 (CPU 411)/adapter server 5 (CPU 511) sets the check result to “NG”, and if the value is equal to or smaller, it sets the result to “OK”.

In S1006, the storage management server 4 (CPU 411)/adapter server 5 (CPU 511) executes S1007 if the check result is “OK”, and executes S1024 if the result is “NG”. In S1024, the storage management server 4 (CPU 411)/adapter server 5 (CPU 511) notifies a maximum value (static) range error to the storage management AP 41/adapter 51.

In S1007, the storage management server 4 (CPU 411)/adapter server 5 (CPU 511) judges whether a minimum value (static) is set as the attribute. If set (S1007: Yes), the storage management server 4 (CPU 411)/adapter server 5 (CPU 511) executes S1008, and if not (S1007: No), it executes S1010. For example, a minimum value (static) is set as attribute in storage management API attribute information 503 through 702.

In S1008, the storage management server 4 (CPU 411)/adapter server 5 (CPU 511) executes a check of the minimum value (static). That is, the storage management server 4 (CPU 411)/adapter server 5 (CPU 511) judges whether the set value is equal to or greater than a minimum value (static) or not. If the set value is smaller than the minimum value, the storage management server 4 (CPU 411)/adapter server 5 (CPU 511) sets the check result to “NG”, and in other cases, it sets the result to “OK”.

In S1009, the storage management server 4 (CPU 411)/adapter server 5 (CPU 511) executes S1010 if the check result is “OK”, and executes S1025 if the result is “NG”. In S1025, the storage management server 4 (CPU 411)/adapter server 5 (CPU 511) notifies a minimum value (static) range error to the storage management AP 41/adapter 51.

In S1010, the storage management server 4 (CPU 411)/adapter server 5 (CPU 511) determines whether a usable value (static) is set as the attribute or not. If set (S1010: Yes), the storage management server 4 (CPU 411)/adapter server 5 (CPU 511) executes S1011, and if not set (S1010: No), it executes S1013.

In S1011, the storage management server 4 (CPU 411)/adapter server 5 (CPU 511) executes a check of the usable value (static). That is, the storage management server 4 (CPU 411)/adapter server 5 (CPU 511) determines whether the set value exists in the usable value (static) or not. If it exists, the storage management server 4 (CPU 411)/adapter server 5 (CPU 511) sets the check result to “OK”, and if not, sets the result to “NG”.

In S1012, the storage management server 4 (CPU 411)/adapter server 5 (CPU 511) executes S1013 if the check result is “OK”, and executes S1026 if the result is “NG”. In S1026, the storage management server 4 (CPU 411)/adapter server 5 (CPU 511) notifies a usable value (static) out-of-range error to the storage management AP 41/adapter 51.

In S1013, the storage management server 4 (CPU 411)/adapter server 5 (CPU 511) judges whether a maximum value (dynamic) is set as the attribute or not. If set (S1013: Yes), the storage management server 4 (CPU 411)/adapter server 5 (CPU 511) executes S1014, and if not (S1013: No), it executes S1016. For example, a maximum value (dynamic) is set as attribute in the storage management API attribute information 503.

In S1014, the storage management server 4 (CPU 411)/adapter server 5 (CPU 511) executes a check of the maximum value (dynamic). That is, the storage management server 4 (CPU 411)/adapter server 5 (CPU 511) judges whether the set value is equal to or smaller than a maximum value (dynamic) or not. If the value exceeds the maximum value, the storage management server 4 (CPU 411)/adapter server 5 (CPU 511) sets the check result to “NG”, and in other cases, it sets the result to “OK”.

In S1015, the storage management server 4 (CPU 411)/adapter server 5 (CPU 511) executes S1016 if the check result is “OK”, and executes S1027 if it is “NG”. In S1027, the storage management server 4 (CPU 411)/adapter server 5 (CPU 511) notifies a maximum value (dynamic) range error to the storage management AP 41/adapter 51.

In S1016, the storage management server 4 (CPU 411)/adapter server 5 (CPU 511) judges whether a minimum value (dynamic) is set as the attribute. If set (S1016: Yes), the storage management server 4 (CPU 411)/adapter server 5 (CPU 511) executes S1017, and if not (S1016: No), it executes S1019.

In S1017, the storage management server 4 (CPU 411)/adapter server 5 (CPU 511) executes a check of the minimum value (dynamic). That is, the storage management server 4 (CPU 411)/adapter server 5 (CPU 511) judges whether the set value is equal to or greater than a minimum value (dynamic) or not. The storage management server 4 (CPU 411)/adapter server 5 (CPU 511) sets the check result to “NG” if the value is smaller than the minimum value, and if the value is equal to or greater, it sets the result to “OK”.

In S1018, the storage management server 4 (CPU 411)/adapter server 5 (CPU 511) executes S1019 if the check result is “OK”, and executes S1028 if the result is “NG”. In S1028, the storage management server 4 (CPU 411)/adapter server 5 (CPU 511) notifies a minimum value (dynamic) range error to the storage management AP 41/adapter 51.

In S1019, the storage management server 4 (CPU 411)/adapter server 5 (CPU 511) judges whether a usable value (dynamic) is set as the attribute. If set (S1019: Yes), the storage management server 4 (CPU 411)/adapter server 5 (CPU 511) executes S1020, and if not (S1019: No), it executes S1022. For example, a usable value (dynamic) is set as the attribute in storage management API attribute information 501 through 502, and in storage management API attribute information 702 through 704.

In S1020, the storage management server 4 (CPU 411)/adapter server 5 (CPU 511) executes a check of the usable value (dynamic). That is, the storage management server 4 (CPU 411)/adapter server 5 (CPU 511) judges whether the set value exists in the usable value (dynamic) or not. If it exists, the storage management server 4 (CPU 411)/adapter server 5 (CPU 511) sets the check result to “OK”, and if not, it sets the result to “NG”.

In S1021, the storage management server 4 (CPU 411)/adapter server 5 (CPU 511) executes S1022 if the check result is “OK”, and executes S1029 if it is “NG”. In S1029, the storage management server 4 (CPU 411)/adapter server 5 (CPU 511) notifies a usable value (dynamic) out-of-range error to the storage management AP 41/adapter 51.

In S1022, the storage management server 4 (CPU 411)/adapter server 5 (CPU 511) stores the value determined as appropriate as a result of the check in the memory 103/313 or the disk 104/314. Then, the storage management server 4 (CPU 411)/adapter server 5 (CPU 511) ends the validity check processing of the integer member. As described, since the storage management server 4 (CPU 411)/adapter server 5 (CPU 511) can judge whether or not the function can be executed by assembling a validity check processing of the integer member as versatile processing to the storage management API library 42/52, even if a new function related to the set numeral value is added to the storage system 1, it is possible to determine whether the function can be executed by the versatile processing or not.

### <Validity Check Processing of Character String Member>

FIG. 12 is a flowchart showing the validity check processing of a character string member. The validity of the requested data is verified via the validity check processing of the character string member. The present processing is executed by the storage management server 4 (CPU 411)/adapter server 5 (CPU 511) using the versatile processing installed in the storage management API library 42/52.

In S1201, the storage management server 4 (CPU 411)/adapter server 5 (CPU 511) determines whether a dependent member is set as the attribute or not. If set (S1201: Yes), the storage management server 4 (CPU 411)/adapter server 5 (CPU 511) executes S1202, and if not (S1201: No), it executes S1204.

In S1202, the storage management server 4 (CPU 411)/adapter server 5 (CPU 511) executes a check of the dependent member. That is, the storage management server 4 (CPU 411)/adapter server 5 (CPU 511) judges whether an appropriate member is set as the dependent member or not. When an appropriate member name is set, the storage management server 4 (CPU 411)/adapter server 5 (CPU 511) sets the check result to “OK”, and if not, it sets the result to “NG”.

In S1203, the storage management server 4 (CPU 411)/adapter server 5 (CPU 511) executes S1204 if the check result is “OK”, and executes S1214 if the result is “NG”. In S1214, the storage management server 4 (CPU 411)/adapter server 5 (CPU 511) notifies a dependent member non-set error to the storage management AP 41/adapter 51.

In S1204, the storage management server 4 (CPU 411)/adapter server 5 (CPU 511) judges whether a maximum character string length is set as the attribute. If set (S1204: Yes), the storage management server 4 (CPU 411)/adapter server 5 (CPU 511) executes S1205, and if not set (S1204: No), it executes S1207. For example, in storage management API attribute information 502, a maximum character string length is set as the attribute.

In S1205, the storage management server 4 (CPU 411)/adapter server 5 (CPU 511) checks the maximum character string length. That is, the storage management server 4 (CPU 411)/adapter server 5 (CPU 511) judges whether the character string length of the set character string is equal to or smaller than a maximum character string length or not. If the length is equal to or smaller than the maximum character string length, it sets the check result to “OK”, and if it is out of range, it sets the result to “NG”.

In S1206, the storage management server 4 (CPU 411)/adapter server 5 (CPU 511) executes S1207 if the check result is “OK”, and executes S1215 if the check result is “NG”. In S1215, the storage management server 4 (CPU 411)/adapter server 5 (CPU 511) notifies a maximum character string length range error to the storage management AP 41/adapter 51.

In S1207, the storage management server 4 (CPU 411)/adapter server 5 (CPU 511) judges whether a minimum character string length is set as the attribute or not. If it is set (S1207: Yes), the storage management server 4 (CPU 411)/adapter server 5 (CPU 511) executes S1208, and if not (S1207: No), it executes S1210. For example, in storage management API attribute information 502, a minimum character string length is set as the attribute.

In S1208, the storage management server 4 (CPU 411)/adapter server 5 (CPU 511) executes a check of the minimum character string length. That is, the storage management server 4 (CPU 411)/adapter server 5 (CPU 511) judges whether the character string length of the character string being set is equal to or greater than a minimum character string length or not. If the length is equal to or greater than a minimum character string length, it sets the check result to “OK”, and if the length is out of range, it sets the check result to “NG”.

In S1209, the storage management server 4 (CPU 411)/adapter server 5 (CPU 511) executes S1210 if the check result is “OK”, and executes S1216 if the check result is “NG”. In S1216, the storage management server 4 (CPU 411)/adapter server 5 (CPU 511) notifies a minimum character string length range error to the storage management AP 41/adapter 51.

In S1210, the storage management server 4 (CPU 411)/adapter server 5 (CPU 511) judges whether usable characters are set as the attribute or not. If set (S1210: Yes), the storage management server 4 (CPU 411)/adapter server 5 (CPU 511) executes S1211, and if not (S1210: No), it executes S1213. For example, in storage management API attribute information 502, usable characters are set as the attribute.

In S1211, the storage management server 4 (CPU 411)/adapter server 5 (CPU 511) executes a check of the usable characters. That is, the storage management server 4 (CPU 411)/adapter server 5 (CPU 511) judges whether the characters used in the set character string are composed only of usable characters or not. If the characters are composed of only usable characters, it sets the check result to “OK”, and if an unusable character is included, it sets the check result to “NG”.

In S1212, the storage management server 4 (CPU 411)/adapter server 5 (CPU 511) executes S1213 if the check result is “OK”, and executes S1217 if the result is “NG”. In S1217, the storage management server 4 (CPU 411)/adapter server 5 (CPU 511) notifies a usable character out-of-range error to the storage management AP 41/adapter 51.

In S1213, the storage management server 4 (CPU 411)/adapter server 5 (CPU 511) stores the value determined as being appropriate as a result of the check in the memory 103/313 or the disk 104/314. Then, the storage management server 4 (CPU 411)/adapter server 5 (CPU 511) ends the validity check processing of the character string member. As described, it becomes possible to judge whether a function can be executed or not by assembling a validity check processing of the character string member as versatile processing to the storage management API library 42/52, so that even if a new function related to the character string is added or extended to the storage system 1, whether the function can be executed or not can be determined by the present versatile processing.

### <Validity Check Processing of Byte Array Member>

FIG. 13 is a flowchart illustrating a validity check processing of a byte array member. The validity of the requested data is verified by the validity check processing of the byte array member. The present processing is executed by the storage management server 4 (CPU 411)/adapter server 5 (CPU 511) using the versatile processing installed in the storage management API library 42/52.

In S1301, the storage management server 4 (CPU 411)/adapter server 5 (CPU 511) judges whether a dependent member is set as the attribute. If it is set (S1301: Yes), the storage management server 4 (CPU 411)/adapter server 5 (CPU 511) executes S1302, and if not (S1301: No), it executes S1304.

In S1302, the storage management server 4 (CPU 411)/adapter server 5 (CPU 511) executes a check of the dependent member. That is, the storage management server 4 (CPU 411)/adapter server 5 (CPU 511) judges whether an appropriate member is set as the dependent member or not. The storage management server 4 (CPU 411)/adapter server 5 (CPU 511) sets the check result to “OK” if an appropriate member name is set, and sets the result to “NG” if an appropriate member name is not set.

In S1303, the storage management server 4 (CPU 411)/adapter server 5 (CPU 511) executes S1304 if the check result is “OK”, and executes S1308 if the result is “NG”. In S1308, the storage management server 4 (CPU 411)/adapter server 5 (CPU 511) notifies a dependent member non-set error to the storage management AP 41/adapter 51.

In S1304, the storage management server 4 (CPU 411)/adapter server 5 (CPU 511) judges whether an array length is set as the attribute. If it is set (S1304: Yes), the storage management server 4 (CPU 411)/adapter server 5 (CPU 511) executes S1305, and if not (S1304: No), it executes S1307. For example, an eight-byte array length is set as attribute in member name “HostWwn” of storage management API attribute information 701.

In S1305, the storage management server 4 (CPU 411)/adapter server 5 (CPU 511) executes a check of the array length. That is, the storage management server 4 (CPU 411)/adapter server 5 (CPU 511) judges whether the array length of the set byte array corresponds to the array length set in the attribute. If they correspond, the check result is set to “OK”, and if not, the check result is set to “NG”.

In S1306, the storage management server 4 (CPU 411)/adapter server 5 (CPU 511) executes S1307 if the check result is “OK” and executes S1309 if it is “NG”. In S1309, the storage management server 4 (CPU 411)/adapter server 5 (CPU 511) notifies an array length incorrect error to the storage management AP 41/adapter 51.

In S1307, the storage management server 4 (CPU 411)/adapter server 5 (CPU 511) stores the value determined as appropriate as a check result to the memory 103/313 or the disk 104/314. Then, the storage management server 4 (CPU 411)/adapter server 5 (CPU 511) ends the validity check processing of the character string member. As described, by assembling a validity check processing of the byte array member as versatile processing to the storage management API library 42/52, it becomes possible to judge whether the function can be executed or not, so that whether the function can be executed or not by the versatile processing can be determined even if a new function related to the byte array is added to the storage system 1.

### <Configuration of Screen in Management Application>

FIG. 14 is a view showing a configuration example of a screen in a management application using the storage management API attribute information. FIG. 14 shows as an example of a case where an LDEV is created (when a createLdev function is executed) in a storage management screen 140.

The storage management screen 140 is composed of an LDEV ID input area 1401 for entering information for uniquely identifying an LDEV, a Nickname input area 1402 for entering information for setting a nickname of the LDEV being created, a Capacity input area 1403 for entering a storage capacity of the LDEV being created, a Pool ID input area 1404 for entering information for uniquely identifying a pool to be associated with the LDEV, an Apply button 1405 for applying the entered information, and a Cancel button 1406 for cancelling the entered information.

The range of the numeric values that can be entered or the maximum character string value and the like are displayed in each input area, and the input of a numeric value exceeding the set range or exceeding the maximum value cannot be accepted. This is because an error is output in the validity check processing of requested data (entered information) in S827. When error is output, an error message may be displayed on the present screen. Further, it is possible to have the input range or the maximum input value highlighted on the display (such as showing the fonts in red or in bold) when error occurs.

As described, by installing a versatile processing in the storage management API library 42/52 and verifying the data requested to the storage management API attribute information by a validity check, which is a versatile processing, there will be no need to add the logic of processing (adding or changing of program) in each storage management AP 41. In addition, the deterioration of processing performance can be prevented since the processes performed by the storage management API providing server program 3 can be reduced. Moreover, the respective storage management AP 41 can be applied speedily to extended functions of the storage system 1 or to a new storage system. Further, since it is possible to generate a new function on the management side of the storage system 1 and to execute the function without using the storage management API providing server program 3, the amount of communication between the storage management AP 41 and the storage management API providing server program 3 can be cut down, and the communication bandwidth can be utilized effectively.

The present invention is not restricted to the above-illustrated preferred embodiments, and can include various modifications. The above-illustrated embodiments are described in detail to help understand the present invention, and the present invention is not restricted to a structure including all the components illustrated above. Further, a portion of the configuration of an embodiment can be replaced with the configuration of another embodiment, or the configuration of a certain embodiment can be added to the configuration of another embodiment. Moreover, a portion of the configuration of each embodiment can be added to, deleted from or replaced with other configurations. A portion or whole of the above-illustrated configurations, functions, processing units, processing means and so on can be realized via hardware configuration such as by designing an integrated circuit. Further, the configurations and functions illustrated above can be realized via software by the processor interpreting and executing programs for realizing the respective functions.

The information such as the programs, tables and files for realizing the respective functions can be stored in storage devices such as memories, hard disks or SSDs (Solid State Drives), or in memory media such as IC cards, SD cards or DVDs. Only the control lines and information lines considered necessary for description are illustrated in the drawings, and not necessarily all the control lines and information lines required for production are illustrated. In actual application, it can be considered that almost all the components are mutually coupled.

### REFERENCE SIGNS LIST

1: Storage system, 3: Storage management API providing server program,
4: Storage management server, 5: Adapter server, 6: Management terminal,
12: Storage management API attribute information,
14: Storage system control program, 15: Storage system configuration information,
22: Storage management API library, 31: SVP, 33: Storage device,
41: Storage management AP, 42/52: Storage management API library,
51: Adapter program, 101/311/411/421/511: CPU,
103/313/413/423/513: Memory, 104/314/414/424/514: Disk,
400/600: Storage management API attribute definition information,
500/700: Storage management API attribute information

1. A storage management system configured including a storage system and a management server, the storage system comprising:
a first CPU; and
a first storage device,
the management server comprising:
a second CPU; and
a second storage device,
the first storage device of the storage system storing:
a storage management API attribute information for connecting the management server and the storage system; and
a storage management API providing server program executed by the first CPU for providing the storage management API attribute information to the management server,
a second storage device of the management server storing:
a storage management application program executed by the second CPU for managing the storage system; and
a storage management API library for operating the storage management application program,
one or more versatile processing programs executed by the second CPU being equipped to the storage management API library,
wherein when the storage management application program is connected via the storage management API library to the storage management API providing server program for executing a given function to the storage system,
the second CPU
acquires the storage management API attribute information from the storage management API providing server program, and
executes the function to the storage system by combining the storage management API attribute information and the versatile processing program of the storage management API library.

2. The storage management system according to claim 1, wherein the storage management API attribute information is configured to
include a function name, a requested data member for executing the given function, and a member of response data which is an execution result of the given function;
wherein a member of the requested data and a member of the response data are configured to include a member name and a type of the relevant member name; and
further include an attribute set for each member name and a set value for the relevant attribute.

3. The storage management system according to claim 2, wherein a storage system configuration information showing the system configuration of the storage system is stored in the first storage device; and
the first CPU refers to the storage system configuration information and updates the storage management API attribute information.

4. The storage management system according to claim 3, wherein
the storage management API attribute information is updated either when the storage management API providing server program is started, or periodically.

5. The storage management system according to claim 2, wherein the second CPU of the management server
sets a requested data for executing the given function to the storage management API attribute information, and
executes confirmation of validity of storage management API attribute information to which the requested data is added using the versatile processing program.

6. The storage management system according to claim 5, wherein the second CPU of the management server checks validity of the storage management API attribute information to which the requested data is added based on a type and value of information set to the requested data.

7. A storage system connected to a management server,
the storage system comprising:
a first CPU; and
a first storage device,
the management server comprising:
a second CPU; and
a second storage device,
the first storage device of the storage system storing;
a storage management API attribute information for connecting the management server and the storage system; and
a storage management API providing server program executed by the first CPU for providing the storage management API attribute information to the management server,
a second storage device of the management server storing:
a storage management application program executed by the second CPU for managing the storage system; and
a storage management API library for operating the storage management application program,
one or more versatile processing programs executed by the second CPU being equipped to the storage management API library,
wherein when the storage management application program is connected via the storage management API library to the storage management API providing server program for executing a given function to the storage system,
the second CPU
acquires the storage management API attribute information from the storage management API providing server program, and
executes the function to the storage system by combining the storage management API attribute information and the versatile processing program of the storage management API library.

8. The storage system according to claim 7, wherein the storage management API attribute information is configured to:
include a function name, a requested data member for executing the given function, and a member of response data which is an execution result of the given function;
wherein a member of the requested data and a member of the response data are configured to include a member name and a type of the relevant member name; and
further include an attribute set for each member name and a set value for the relevant attribute.

9. The storage system according to claim 8, wherein a storage system configuration information showing the system configuration of the storage system is stored in the first storage device; and
the first CPU refers to the storage system configuration information and updates the storage management API attribute information.

10. The storage system according to claim 9, wherein
the storage management API attribute information is updated either when the storage management API providing server program is started, or periodically.

11. The storage system according to claim 8, wherein a second CPU of the management server
sets a requested data for executing the given function to the storage management API attribute information; and
executes confirmation of validity of storage management API attribute information to which the requested data is added using the versatile processing program.

12. The storage system according to claim 11, wherein the second CPU of the management server confirms validity of the storage management API attribute information to which the requested data is added using a type and value of information set to the requested data.

13. A method for extending function of a storage system connected to a management server, the storage system comprising:
a first CPU; and
a first storage device,
the management server comprising:
a second CPU; and
a second storage device,
the first storage device of the storage system storing:
a storage management API attribute information for connecting the management server and the storage system; and
a storage management API providing server program executed by the first CPU for providing the storage management API attribute information to the management server,
a second storage device of the management server storing:
a storage management application program executed by the second CPU for managing the storage system; and
a storage management API library for operating the storage management application program,
one or more versatile processing programs executed by the second CPU being equipped to the storage management API library;
wherein when the storage management application program is connected via the storage management API library to the storage management API providing server program for executing a given function to the storage system;
the second CPU
acquires the storage management API attribute information from the storage management API providing server program; and
executes the function to the storage system by combining the storage management API attribute information and the versatile processing program of the storage management API library.

14. The method for extending function of a storage system according to claim 13, wherein the storage management API attribute information is configured to
include a function name, a requested data member for executing the given function, and a member of response data which is an execution result of the given function;
wherein a member of the requested data and a member of the response data are configured to include a member name and a type of the relevant member name; and
further include an attribute set for each member name and a set value for the relevant attribute.

15. The method for extending function of a storage system according to claim 14, wherein a storage system configuration information showing the system configuration of the storage system is stored in the first storage device; and
the first CPU refers to the storage system configuration information and updates the storage management API attribute information.
